(19) United States
(12) Patent Application Publication
(10) Pub. No.: US 2007/0047673 A1
(43) Pub. Date: Mar. 1, 2007

(54) Intermediate frequency receivers

(75) Inventors: Changqing Xu, Singapore (SG); Zhiping Li, Singapore (SG); Tingwu Wang, Singapore (SG); Masayuki Tomisawa, Singapore (SG)

Correspondence Address: VENABLE LLP, P.O. BOX 34385, WASHINGTON, DC, 20043-9998, US

(73) Assignee: Oki Techno Centre (Singapore) Pte Ltd, Singapore (SG)

(21) Appl. No.: 11/508,315

(22) Filed: Aug. 23, 2006

(30) Foreign Application Priority Data
Aug. 23, 2005 (SG) 200505405-1

(51) Int. Cl. H04L 27/22

(52) U.S. Cl. 375/332

(57) ABSTRACT

There is provided an apparatus and method for isolating an in-phase component I and a quadrature component Q of a received IF signal and for filtering the received signal. The apparatus comprises a DDC for sampling the received signal at four times the frequency of the received signal, each sample having an order k and a filter for reducing noise outside a required bandwidth. The filter has n taps and comprises a first filter portion for receiving the samples where k is even and for outputting an in-phase component I of the received signal and a second filter portion for receiving the samples where k is odd and for outputting a quadrature component Q of the received signal. The first filter portion has x taps and the second filter portion has y taps and x+y=n.

### FIELD OF THE INVENTION

The invention relates to an apparatus and method for isolating I and Q components of a received IF signal and for filtering the received signal. In particular, the invention relates to an apparatus and method for performing the combined functions of a digital down converter and a filter.

### BACKGROUND OF THE INVENTION

A Digital Down Converter (DDC) is a key component of digital receivers in many communication systems. The DDC is some kind of digital mixer and is used to recover the in-phase I and quadrature Q components of a received signal.

As shown in FIG. 1, the I component is formed by multiplying the received signal by a cosine function and the Q component is formed by multiplying the received signal by a sine function. The received signal may be an IF signal and may be expressed as:
Sₖ=Aₖ cos{2πf_{IF}kTₛ+φₖ}
where k is the sample number (also known as the order), Aₖ is amplitude of the sampled IF signal at sample Sₖ, f_{IF} is the intermediate frequency, Tₛ is the time between one sample and the next i.e. the sampling interval and φₖ is the phase of the sampled IF signal at sample k.

The I channel is formed by multiplying Sₖ by cos{2πf_{IF}kTₛ} at block 101 and the Q channel is formed by multiplying Sₖ by −sin{2πf_{IF}kTₛ} at block 103. The resulting I and Q components therefore have the form:
Iₖ=Aₖ cos{2πf_{IF}kTₛ+φₖ}cos{2πf_{IF}kTₛ}
and
Qₖ=−Aₖ cos{2πf_{IF}kTₛ+φₖ}sin{2πf_{IF}kTₛ}.

Usually, the DDC is followed by some sort of low pass filter. The low pass filter primarily reduces noise outside the required bandwidth but may also perform pulse shaping, to reduce the bandwidth of the signal without introducing intersymbol interference. The filter may be a simple low pass filter (LPF) or a raised cosine filter or a root raised cosine (RRC) filter or any other suitable type of filter. Because the I and Q components are already isolated by the DDC, two filters are required (one for the I channel and one for the Q channel) as shown in FIG. 2, in which the I channel filter is labeled 201 and the Q channel filter is labeled 203.

In some cases, the DDC can be simplified. For example, if the sampling frequency fₛ of the DDC is four times the intermediate frequency f_{IF} i.e. fₛ=4f_{IF}, then we can simplify the sine and cosine functions. This is because, over one cycle, cos x takes the values 1, 0, −1 and 0 and −sin x takes the values 0, −1, 0 and 1. So, to produce the I channel, we multiply the incoming signal Sₖ by 1, 0, −1 and 0 at successive samples and, to produce the Q channel, we multiply the incoming signal Sₖ by 0, −1, 0 and 1 at successive samples. This produces I components of the forms Iₖ=Sₖ,0,−Sₖ,0 over a single cycle of the intermediate frequency signal and Q components of the forms Qₖ=0,−Sₖ,0,Sₖ over a single cycle of the intermediate frequency signal.

Some known arrangements make use of this DDC simplification to also simplify the subsequent filters. One such known arrangement is shown in FIG. 3. In the FIG. 3 arrangement, the sampling rate of the DDC is four times the intermediate frequency so we can make use of the sine and cosine simplifications described above. This is shown schematically by the sampled cosine plot A above the simplified DDC I channel block 301 and the sampled −sine plot B under the simplified DDC Q channel block 303. The DDC is followed by decimators 305 and 307 to reduce the sampling rate by half i.e. to fₛ/2. Because the sampling rate is halved, this can reduce the complexity of the subsequent RRC filters 309 and 311 to half, which obviously has advantages. However, in order to achieve this, the I and Q components must be sampled at different time instants because of the quarter cycle phase difference between the sine and cosine functions. This is shown schematically by the sampled cosine plot C above the I channel decimator 305 and the sampled sine plot D below the Q channel decimator 307. This misalignment between the I and Q components can cause some degradation of the signal. Thus, even though the FIG. 3 arrangement reduces the filter complexity, some degradation is unfortunately introduced.

### SUMMARY OF THE INVENTION

It is an object of the invention to provide a method and apparatus for performing the combined functions of a DDC and filter, which mitigate or substantially overcome the problems associated with known arrangements described above.

According to a first aspect of the invention, there is provided apparatus for isolating an in-phase component I and a quadrature component Q of a received intermediate frequency (IF) signal and for filtering the received signal, the apparatus comprising:
a digital down converter (DDC) for sampling the received signal at four times the frequency of the received signal, each sample having an order k;
a filter for reducing noise outside a required bandwidth, the filter having n taps and comprising: a first filter portion for receiving the samples where k is even and for outputting an in-phase component I of the received signal, the first filter portion having x taps; a second filter portion for receiving the samples where k is odd and for outputting a quadrature component Q of the received signal, the second filter portion having y taps; wherein x+y=n.

The apparatus acts as a combined digital down converter (DDC) and filter i.e. it performs two functions. Firstly, it isolates the I and Q components from the received IF signal. Secondly, it filters the received signal to reduce noise outside the required bandwidth. By using separate filter portions for the odd k and even k samples, so that the total number of taps in the two portions is n, the filter can provide the performance of a n-tapped filter while allowing each filter portion to have about half the complexity of a n-tapped filter.

Preferably, the DDC is arranged to input samples where k is even into the first filter portion and to input samples where k is odd into the second filter portion. Preferably, n is odd and

$$x = \frac{n + 1}{2} and y = \frac{n - 1}{2} .$$

Thus, the first filter portion handles samples k=0, 2, 4, . . . , n−1 and the second filter portion handles samples k=1, 3, 5, . . . , n−2. An odd value of n is preferred because this means that the peak of the filter's frequency response is defined by a single value rather than two equal values. However, n could be even, in which case x may equal n/2 and y may equal n/2.

In one embodiment, the first and second filter portions are finite impulse response (FIR) filters. In that embodiment, in one case n=25. In that embodiment, pulse shaping is performed only in the transmitter which transmitted the signals and no pulse shaping is performed in the filter.

In an alternative embodiment, the filter may be arranged to perform pulse shaping of the received signal. In that embodiment, in a first arrangement, the first and second filter portions are finite impulse response (FIR) filters. In that case, the apparatus may further comprise apparatus for pulse shaping the received signal. The pulse shaping apparatus may comprise a raised cosine filter (in which case, the FIR filters perform low pass filtering, the raised cosine filter(s) perform pulse shaping, and no pulse shaping is performed in the transmission side). Alternatively, the pulse shaping apparatus may comprise a root raised cosine (RRC) filter (in which case, the FIR filters perform low pass filtering, the RRC filter(s) perform pulse shaping, and some pulse shaping is also performed in the transmission side).

In that embodiment, in a second arrangement, the first and second filter portions each comprise all or part of a raised cosine filter. In that case, the first and second filter portions may each comprise a root raised cosine (RRC) filter. In that embodiment, in one case, n=97. If the first and second filter portions each comprise a RRC filter, there will usually be at least one other RRC filter in the transmitter which transmitted the signals. The at least one RRC filter in the receiver together with the at least one RRC filter in the transmitter together provide raised cosine function pulse shaping of the signal.

The apparatus may further comprise a differential decoder for performing differential detection of I and Q over a given symbol span. The differential decoder may be arranged to perform differential detection of I and Q over a symbol span of one symbol. Of course, other symbol spans can also be envisaged.

The differential decoder may comprise a decision block for converting the differentially decoded I into an I output and for converting the differentially decoded Q into a Q output, the I output and the Q output each taking a value of either 0 or 1.

In one embodiment, the apparatus further comprises a converter for converting the received signal to a digital signal. In that embodiment, the converter may be an analogue to digital converter (ADC). The ADC may operate at a frequency which is four times the frequency of the received signal. Alternatively, in that embodiment, the converter may be a hard limiter.

In one arrangement, the apparatus further comprises a decimator for reducing sampling frequency of the received signal. This is particularly advantageous if the apparatus includes a hard limiter for digitizing the received signal. In that embodiment, the hard limiter may operate at a frequency which is sixteen times the frequency of the received signal and the decimator may reduce the frequency to four times the frequency of the received signal. A decimator may also be included if the apparatus uses an ADC for digitizing the received signal.

The decimator may be a cascaded integrator comb (CIC) filter. A CIC filter is advantageous for performing decimation since it does not include multipliers.

The received signal may be a differentially encoded phase shift keyed (DPSK) signal. In one example, the received signal is

$$\frac{π}{4} DQPSK$$

modulated.

According to the invention, there is also provided a receiver for intermediate frequency signals, the receiver comprising apparatus according to the first aspect of the invention.

According to a second aspect of the invention, there is provided a method for isolating an in-phase component I and a quadrature component Q of a received intermediate frequency (IF) signal and for filtering the received signal, the method comprising the steps of:
a) sampling the received signal at four times the frequency of the received signal, each sample having an order k;
b) filtering the signal in a filter having n taps by: i) inputting samples where k is even into a first filter portion, to generate an in-phase component I of the received signal, the first filter portion having x taps; and ii) inputting samples where k is odd into a second filter portion to generate a quadrature component Q of the received signal, the second filter portion having y taps, wherein x+y=n.

Preferably, n is odd and

$$x = \frac{n + 1}{2} and y = \frac{n - 1}{2} .$$

Thus, the first filter portion handles samples k=0, 2, 4, . . . , n−1 and the second filter portion handles samples k=1, 3, 5, . . . , n−2.

The first and second filter portions may be finite impulse response (FIR) filters.

The method may further comprise the step of pulse shaping the received signal. In that case, the first and second filter portions may each comprise a finite impulse response (FIR) filter; then, the pulse shaping is performed separately. Alternatively, the first and second filter portions may each comprise all or part of a raised cosine filter. The first and second filter portions may each comprise a root raised cosine (RRC) filter. In that case, there will usually be at least one other RRC filter in the transmitter which transmitted the signals. The at least one RRC filter in the receiver together with the at least one RRC filter in the transmitter together provide raised cosine function pulse shaping of the signal.

The method may further comprise the step of performing differential detection of I and Q over a given symbol span. The differential detection of I and Q may be performed over a symbol span of one symbol. The method may further comprise the steps of converting the differentially decoded I into an I output and converting the differentially decoded Q into a Q output, the I output and the Q output each taking a value of either 0 or 1.

The method may further comprise the step of converting the received signal to a digital signal. In one embodiment, the step of converting the received signal to a digital signal is performed in an analogue to digital converter (ADC). In that embodiment, the ADC may operate at a frequency which is four times the frequency of the received signal. In an alternative embodiment, the step of converting the received signal to a digital signal is performed in a hard limiter. In that embodiment, the hard limiter may operate at a frequency which is sixteen times the frequency of the received signal.

The method may further comprise the step of reducing sampling frequency of the received signal. The step of reducing the sampling frequency may be performed in a cascaded integrator comb (CIC) filter. A CIC filter is advantageous for performing decimation since it does not include multipliers.

The received signal may be a differentially encoded phase shift keyed (DPSK) signal. The received signal may be

$$\frac{π}{4} DQPSK$$

modulated.

According to the invention, there is also provided apparatus for carrying out a method according to the second aspect of the invention. According to the invention, there is also provided a receiver for intermediate frequency signals, for carrying out a method according to the second aspect of the invention.

According to a third aspect of the invention, there is provided a method for isolating an in-phase component I and a quadrature component Q of a received intermediate frequency (IF) signal and for filtering the received signal, the method comprising the steps of:
a) bandpass sampling the received signal by: i) isolating an aliased signal from the received signal; and ii) sampling the aliased signal at four times the frequency of the aliased signal, each sample having an order k; and
b) filtering the signal in a filter having n taps by: i) inputting samples where k is even into a first filter portion, to generate an in-phase component I of the received signal, the first filter portion having x taps; and ii) inputting samples where k is odd into a second filter portion to generate a quadrature component Q of the received signal, the second filter portion having y taps, wherein x+y=n.

Features described in relation to one aspect of the invention may also be applicable to another aspect of the invention.

### BRIEF DESCRIPTION OF THE DRAWINGS

A known arrangement has already been described with reference to FIGS. 1 to 3 of the accompanying drawings, of which

FIG. 1 is a schematic diagram of a DDC;

FIG. 2 is a diagram of the DDC of FIG. 1 also including low pass filters; and

FIG. 3 is a diagram of a known arrangement incorporating a simplified DDC and filter.

By way of example, preferred embodiments of the invention will now be described with reference to FIGS. 4 to 8 of the accompanying drawings, of which:

FIG. 4 is a block diagram of a receiver according to a first embodiment of the invention;

FIG. 5 is a detailed diagram of block 407 of FIG. 4;

FIG. 6 is a block diagram of a receiver according to a second embodiment of the invention;

FIG. 7 is a detailed diagram of block 605 of FIG. 6; and

FIG. 8a, are frequency plots showing how the invention may be used with 8b and 8c bandpass sampling.

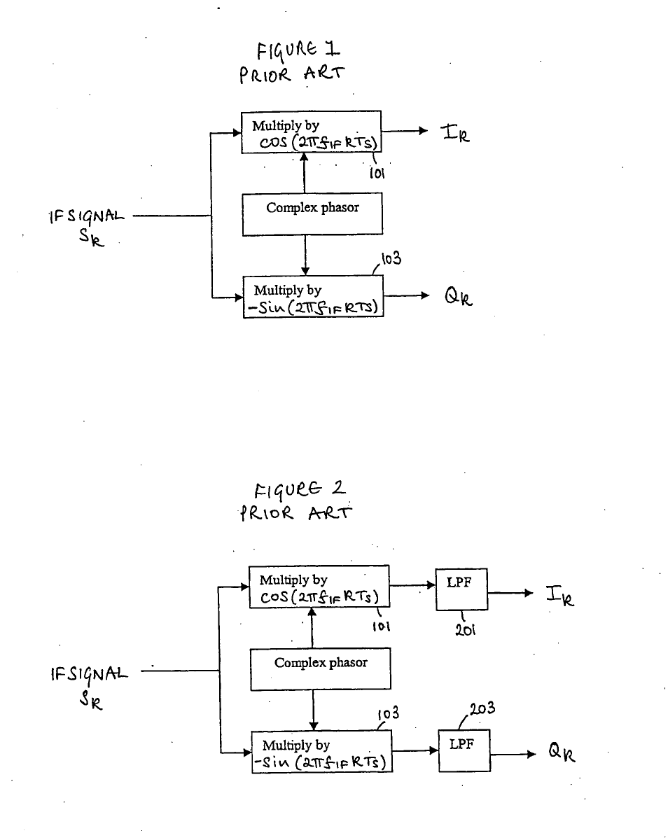

### DETAILED DESCRIPTION OF PREFERRED EMBODIMENTS

Two embodiments will be described and both show receivers for

$$\frac{π}{4} DQPSK ,$$

but the invention is not limited to

$$\frac{π}{4} DQPSK$$

and could apply to any IF signal, whether or not differentially encoded phase shift keyed.

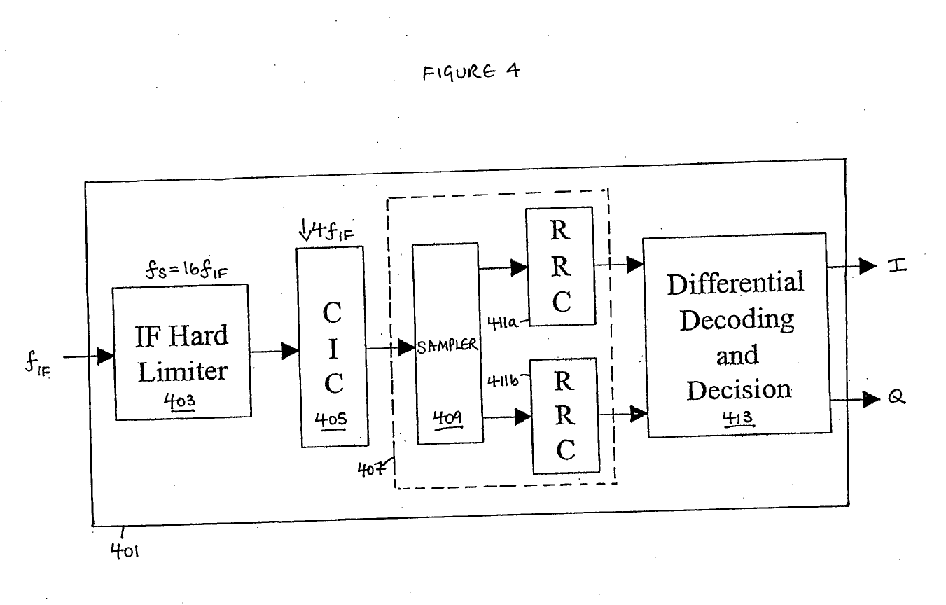

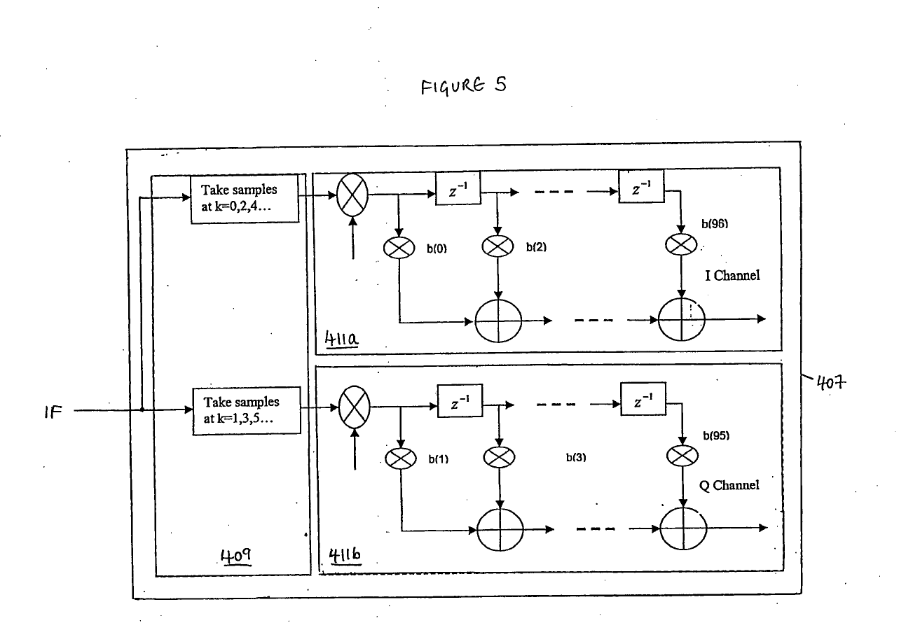

FIG. 4 shows a block diagram of a

$$\frac{π}{4} DQPSK$$

intermediate frequency (IF) receiver 401 according to a first embodiment of the invention. The receiver includes an IF Hard Limiter 403, a Cascaded Integrator Comb (CIC) filter 405, a combined DDC and filter 407 comprising a DDC 409, and Root Raised Cosine (RRC) filters 411a and 411b and a differential decoder and decision block 413. The input to the receiver 401 is an analogue IF signal and the outputs of the receiver 401 are I and Q signals.

The IF Hard Limiter 403 receives the analogue IF signal and performs digitization. The output of the IF Hard Limiter 403 is a 2-level i.e. 1-bit IF signal. The Hard Limiter in this embodiment operates at a sampling rate fₛ which is sixteen times the frequency of the IF signal i.e. fₛ=16f_{IF}.

The CIC filter 405 performs decimation of the signal from the IF Hard Limiter 403. A CIC filter is very efficient for performing decimation (or interpolation) since it does not contain multipliers. The CIC filter 405 may have its usual structure i.e. an integrator portion comprising N integrator stages clocked at rate fₛ, a downsampler for reducing the sampling rate to fₛ/R and a comb portion comprising N comb stages clocked at rate fₛ/R. In this embodiment, R=4 so that the sampling rate at the output of the CIC filter 405 and the input to the DDC 409 is

$$\frac{{f}_{s}}{4} = \frac{16 {f}_{IF}}{4} = 4 {f}_{IF} .$$

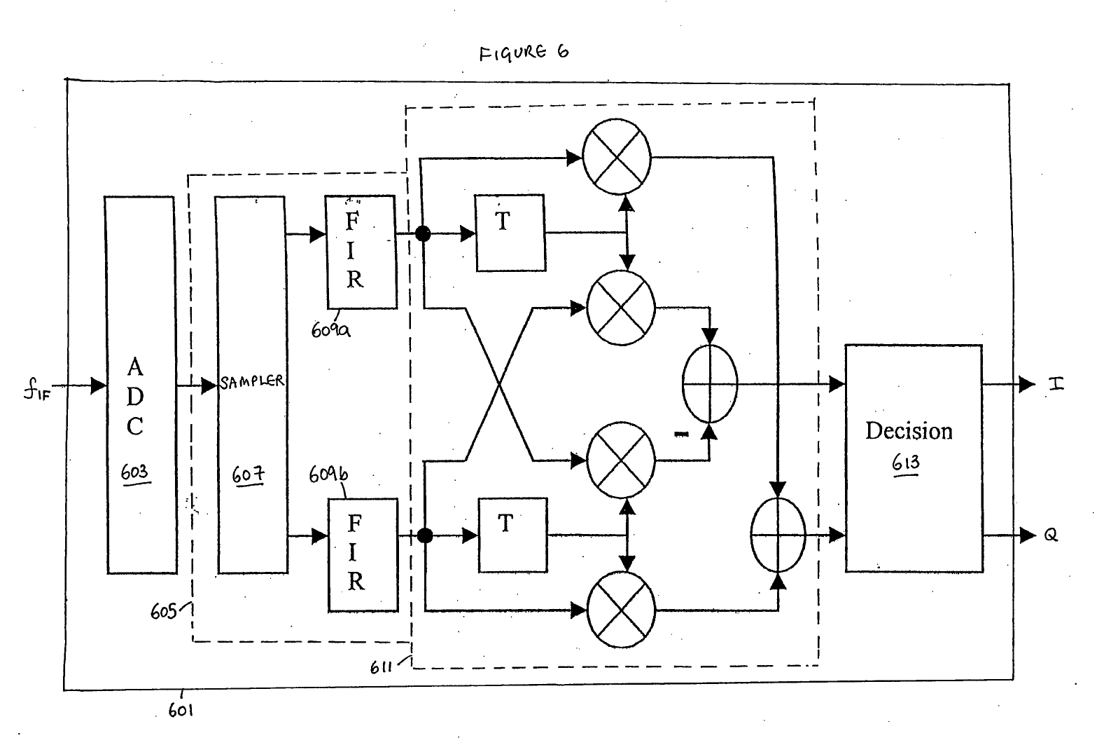

FIG. 5 shows the combined DDC and filter 407 in more detail. The combined DDC and filter 407 comprises DDC 409 and RRC filters 411a and 411b.

As already discussed, the purpose of a DDC is to isolate the I and Q components of the digitized IF signal. The purpose of an RRC filter is to perform pulse shaping and to reduce noise outside the required bandwidth. A standard RRC comprises a number n of taps in succession. Any number n can be chosen for the RRC filter (as long as the filter's frequency response meets the system requirements) but we usually prefer an odd number of taps so that the centre of the filter's impulse response will be a peak (rather than two equal values). Also, the greater the number of taps, the more attenuation there will be outside the desired bandwidth, but the greater the filter complexity and delay. In the combined DDC and filter 407, the two functions (of a DDC and of RRC filter(s)) are not strictly separated and the combined DDC and filter 407 overall performs the two functions together.

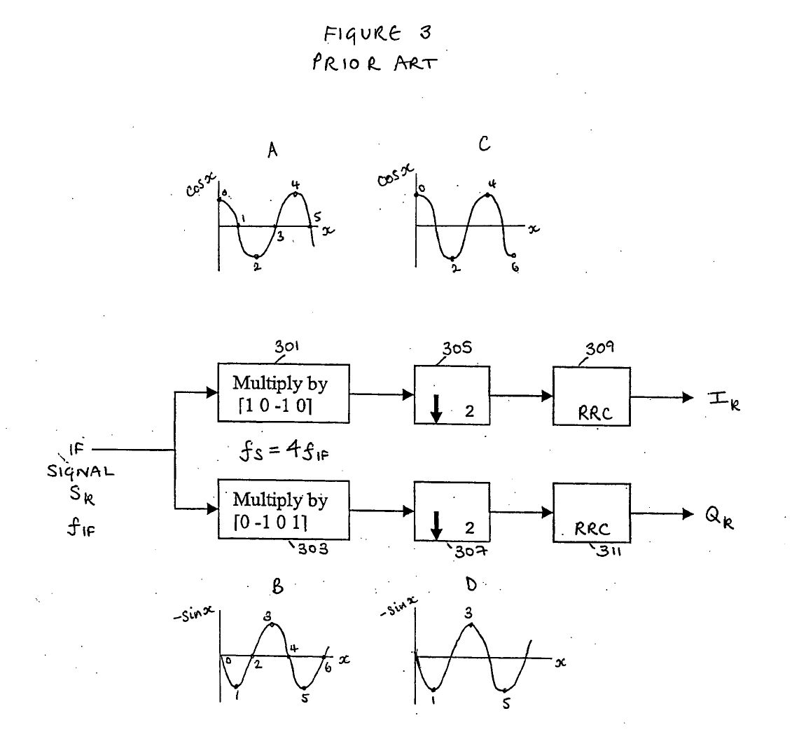

In this case, the sampling rate at the input to the combined DDC and filter 407 is 4f_{IF} so we can make use of the simplification described above with reference to FIG. 3. The above described simplified arrangement multiplied the incoming signal by 1, 0, −1 and 0 at successive samples to produce the I channel and multiplied the incoming signal by 0, −1, 0 and 1 at successive samples to produce the Q channel. So, for both the I channel and the Q channel, we are only interested in alternate samples: even-ordered samples (k=0, 2, 4, 6 . . . ) for the I channel and odd-ordered samples (k=1, 3, 5, 7 . . . ) for the Q channel. We can ignore the odd-ordered samples for the I channel since they are always equal to zero and, similarly, we can ignore the even-ordered samples for the Q channel since they are always equal to zero.

Thus, in the DDC 409 we take samples (of order k) four times in each cycle of the received signal. The even ordered samples are input into the I channel RRC filter 411a and the odd-ordered samples are input into the Q channel RRC filter 411b. By separating odd and even ordered samples, the effect is to isolate the I and Q components. RRC filter 411a is used for the I channel so is only interested in even-ordered samples i.e. where k=0, 2, 4, 6 . . . . Thus, if we want the overall effect of an n-tapped RRC filter where n is odd, in RRC filter 411a, we actually only need to implement

$$\frac{n + 1}{2}$$

taps. The

$$\frac{n + 1}{2}$$

taps will be for the even-ordered samples (k=0, 2, 4, . . . , n−1), because the odd-ordered samples will always equal zero. Similarly, RRC filter 411b is used for the Q channel so is only interested in odd-ordered samples i.e. where k=1, 3, 5, 7 . . . . Thus, if we want the overall effect of an n-tapped RRC filter where n is odd, in RRC filter 411b, we actually only need to implement

$$\frac{n - 1}{2}$$

taps. The

$$\frac{n - 1}{2}$$

taps will be for the odd-ordered samples (k=1, 3, 5, . . . , n−2), because the even-ordered samples will always equal zero.

Thus, filter 411a has

$$\frac{n + 1}{2}$$

taps and filter 411b has

$$\frac{n - 1}{2}$$

taps, making a total of n taps between the two filters. In this embodiment, n=97 so that filter 411a has 49 taps and filter 411a has 48 taps. Thus, the filters between them have exactly the same performance as a 97-tap filter but the complexity of each filter is approximately halved.

In the combined DDC and filter 407, we are able to perform filtering as well as I and Q isolation. By combining the DDC and filter functions together, we are able to approximately halve the complexity of each filter without introducing the degradation associated with prior art arrangements like that shown in FIG. 3.

Referring once again to FIG. 4, the I and Q signals output from the combined DDC and filter 407 are input into the differential decoder and decision block 413. The differential decoder performs differential decoding of the incoming I and Q signals over a symbol span of one symbol, as follows:
Iₒᵤₜ(k)=Iᵢₙ(k)*Iᵢₙ(k−1)+Qᵢₙ(k)*Qᵢₙ(k−1)
Qₒᵤₜ(k)=Qᵢₙ(k)*Iᵢₙ(k−1)−Iᵢₙ(k)*Qᵢₙ(k−1)

After differential decoding, the I and Q signals are input into the decision portion of block 413. The decision rule might be something like

If Iₒᵤₜ>0, I=0 else I=1

If Q₃>0, Q=0 else Q=1

or any other suitable decision algorithm.

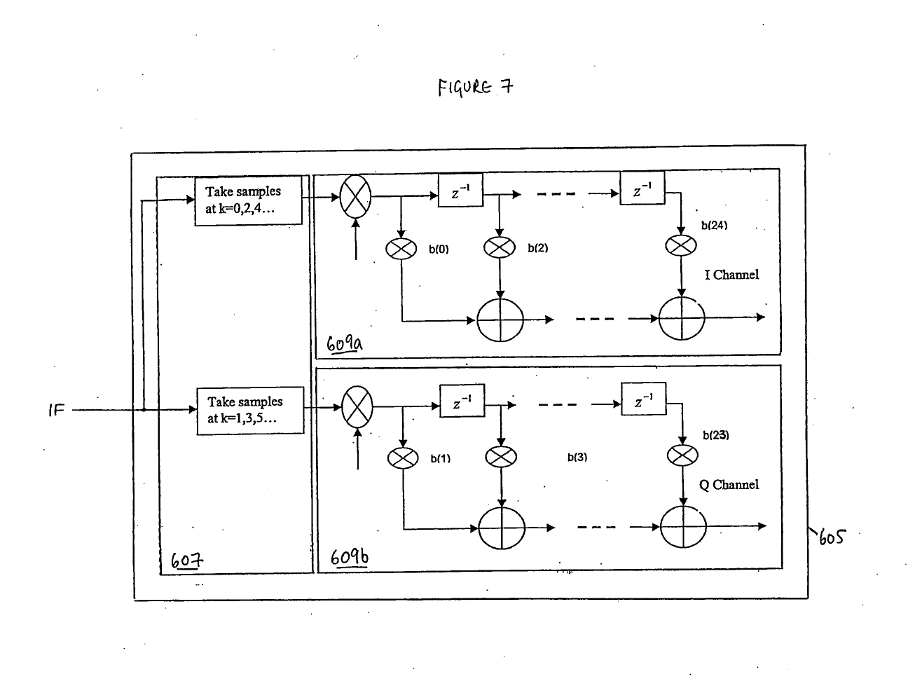

FIG. 6 shows a block diagram of a

$$\frac{π}{4} DQPSK$$

intermediate frequency (IF) receiver 601 according to a second embodiment of the invention. The receiver includes an Analogue-to-Digital Converter (ADC) 603, a combined DDC and filter 605 comprising a DDC 607 and Finite Impulse Response (FIR) filters 609a and 609b, a differential decoder 611 and a decision block 613. As with the first embodiment, the input to the receiver 601 is an analogue IF signal and the outputs of the receiver 601 are I and Q signals.

In this embodiment, the ADC 603 converts the received analogue signal to a digital signal. The operating sampling frequency fₛ of the ADC is four times the frequency of the IF signal i.e. fₛ=4f_{IF}. Note that, in the first embodiment, signal digitization was performed by the IF hard limiter 403 whereas, in this second embodiment, signal digitization is performed by the ADC 603. Both arrangements have advantages and disadvantages: an ADC will usually be able to operate at a lower sampling rate than a hard limiter which will result in a lower power consumption, but the complexity and circuit size of an ADC based system could be higher than that of a hard limiter based system.

In this embodiment, because of the lower sampling rate of the ADC, no decimation of the signal is required. So, no CIC filter (or other downsampler) is included in the receiver 601. In other embodiments, however, a decimator might be required with the ADC.

FIG. 7 shows the combined DDC and filter 605 in more detail. The combined DDC and filter 605 comprises DDC 607 and FIR filters 609a and 609b. In the combined DDC and filter 605, the two functions (of a DDC and of filter(s)) are not strictly separated and the combined DDC and filter 605 overall performs the two functions together.

As usual, the purpose of a DDC is to isolate the I and Q components of the digitized IF signal. As before, since the sampling rate of the DDC is 4f_{IF}, we can simplify the cosine function (for the I channel) by multiply the incoming signal by 1, 0, −1 and 0 at successive samples and we can simplify the sine function (for the Q channel) by multiplying the incoming signal by 0, −1, 0 and 1 at successive samples. So, once again, we are only interested in the even orders (k=0, 2, 4, . . . ) for the I channel and in the odd orders (k=1, 3, 5, . . . ) for the Q channel.

In this embodiment, we are using simple FIR filters 609a and 609b rather than RRC filters because we do not require any pulse shaping in the receiver 601. This may be the case if all the pulse shaping has already been performed in the transmitter or if we are performing some or all of the pulse shaping elsewhere in the receiver side. Thus, the purpose of the FIR filters is simply to select the required bandwidth and cut out noise outside that bandwidth. Thus, the FIR filters act as simple low pass filters. A standard FIR filter comprises a number n of taps in succession, the number of taps being chosen in accordance with the desired frequency response.

In the DDC 607, we take samples (of order k) four times in each cycle of the received signal. The even ordered samples are input into the I channel FIR filter 609a and the odd-ordered samples are input into the Q channel FIR filter 609b. By separating odd and even ordered samples, we are effectively able to isolate the I and Q channels. FIR filter 609a is used for the I channel so is only interested in even-ordered samples i.e. where k=0, 2, 4, 6 . . . . Thus, if we want the effect of an n-tapped FIR filter where n is odd, in FIR filter 609a, we actually only need to implement

$$\frac{n + 1}{2}$$

taps. The

$$\frac{n + 1}{2}$$

taps will be for the even-ordered samples (k=0, 2, 4, . . . , n−1), because the odd-ordered samples will always equal zero. Similarly, FIR filter 609b is used for the Q channel so is only interested in odd-ordered samples i.e. where k=1, 3, 5, 7 . . . . Thus, if we want the effect of an n-tapped FIR filter where n is odd, in FIR filter 609b, we actually only need to implement

$$\frac{n - 1}{2}$$

taps. The

$$\frac{n - 1}{2}$$

taps will be for the odd-ordered samples (k=1, 3, 5, . . . , n−2), because the even-ordered samples will always equal zero.

Thus, filter 609a has

$$\frac{n + 1}{2}$$

taps and filter 609b has

$$\frac{n - 1}{2}$$

taps, making a total of n taps between the two filters. In this embodiment, n=25 so that filter 609a has 13 taps and filter 609b has 12 taps. Thus, the filters have exactly the same performance as a 25-tap filter but the complexity of each filter is approximately halved.

Just like in the combined DDC and filter 407 shown in FIG. 5, in the combined DDC and filter 605, we are able to perform filtering as well as I and Q isolation. By combining the DDC and filter functions together, we are able to approximately halve the complexity of each filter without introducing the degradation associated with prior art arrangements like that shown in FIG. 3.

Referring once again to FIG. 6, the I and Q signals output from the combined DDC and filter 605 are input into the differential decoder 611 and then into the decision block 613. The differential decoder performs differential decoding of the incoming I and Q signals over a symbol span of one symbol, as follows:
Iₒᵤₜ(k)=Iᵢₙ(k)*Iᵢₙ(k−1)+Qᵢₙ(k)*Qᵢₙ(k−1)
Qₒᵤₜ(k)=Qᵢₙ(k)*Iᵢₙ(k−1)−Iᵢₙ(k)*Qᵢₙ(k−1)

In FIG. 6, the structure of the differential decoder 611 is shown in detail but it will be appreciated that the structure of the differential decoder in FIG. 4, although not shown explicitly, may be identical or similar to the arrangement shown in FIG. 6.

After differential decoding, the I and Q signals are input into the decision block 613. The decision rule might be something like

If Iₒᵤₜ>0, I=0 else I=1

If Qₒᵤₜ>0, Q=0 else Q=1

or any other suitable decision algorithm.

It should be noted that, in both first and second embodiments described above, the total number of taps in the filter (n) is an odd number. This is usually preferred because it results in the frequency peak of the filter's frequency response being defined by a single value rather than two equal values. However, other embodiments could be envisaged where n is an even number. In that case, the I channel filter (whether an RRC, an FIR, an LPF or another type of filter) would most likely implement n/2 taps and the Q channel filter (whether an RRC, an FIR, an LPF or another type of filter) would most likely implement n/2 taps.

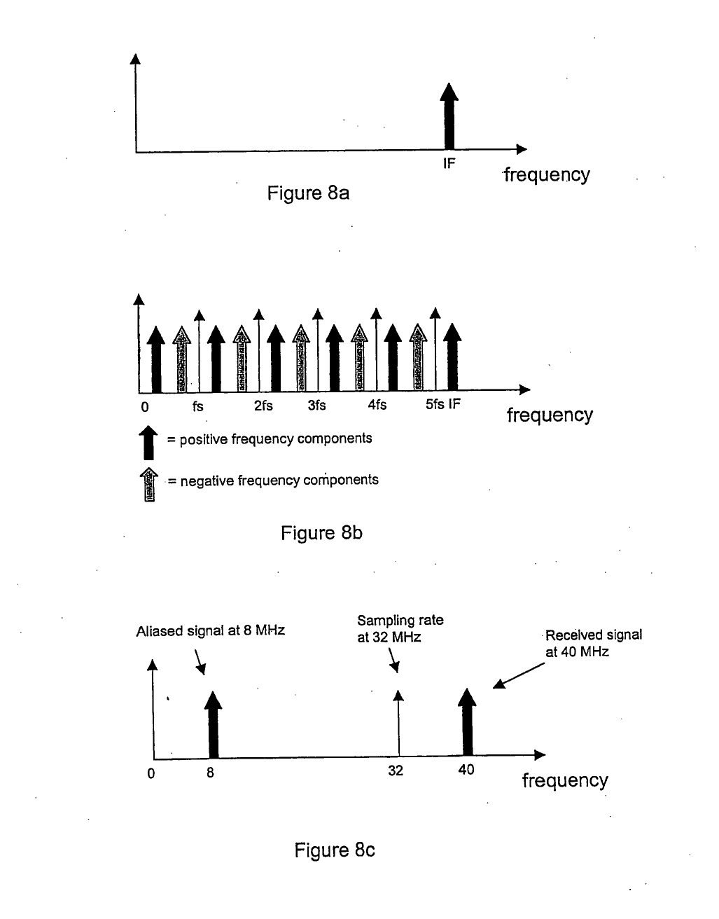

An application of the invention will now be described with reference to FIGS. 8a, 8b and 8c. In this description, we are assuming that an intermediate frequency (IF) receiver is used to demodulate

$$\frac{π}{4} DQPSK$$

signals.

In this application, bandpass sampling is used to perform signal digitization. Bandpass sampling is described in Gary J. Saulnier, etc “A VLSI Demodulator for Digital RF Network Applications: Theory and Results”, IEEE Journal on Selected Areas in Communications, Vol. 8. No. 8 pp. 1500-1511, October 1990 and also in Rodney G Vaughan, etc “The Theory of Bandpass Sampling”, IEEE Transactions on Signal Processing, Vol. 39, No. 9 pp. 1973-1984, September 1991. The idea of bandpass sampling is that the sampling rate can be lowered from twice the maximum frequency of the signal 2f_{MAX} to 2(f_{MAX}−f_{MIN}) where the signal being sampled is bandpass i.e. has non-zero content only in the band between f_{MIN} and f_{MAX}. That is, in this invention, the sampling rate can be lower than the frequency of the IF signal.

FIG. 8a shows the signal spectrum in the analogue domain i.e. before analogue to digital conversion. The signal is centered on the IF frequency.

FIG. 8b shows the signal spectrum in the digital domain i.e. after analogue to digital conversion using bandpass sampling. If the intermediate frequency is f_{IF} and the sampling frequency is fₛ, in order to be able to make the required DDC simplification of the invention, we require

$$mod ( {f}_{IF} , {f}_{s} ) = \frac{{f}_{s}}{4}$$

and, as shown in FIG. 8b, we obtain positive and negative frequency components centered around each integer multiple of the sampling frequency fₛ. The positive frequency components are shown in black and the negative frequency components are shown in grey. Then, a low pass filter can be used to extract the signal we require i.e. at one quarter of the sampling frequency.

Note that the sampling rate should be selected carefully to make sure no aliased signal appears at half the sampling rate.

In one example, shown in FIG. 8c, the received frequency f_{IF} is 40 MHz and we are sampling at 32 MHz=fₛ. This satisfies

$$mod ( {f}_{IF} , {f}_{s} ) = \frac{{f}_{s}}{4} .$$

So, in this example, one of the aliased signals appears at 8 MHz, which is one quarter of the sampling rate. Thus, we can make use of the DDC simplification as described above.

1. Apparatus for isolating an in-phase component I and a quadrature component Q of a received intermediate frequency (IF) signal and for filtering the received signal, the apparatus comprising:
a digital down converter (DDC) for sampling the received signal at four times the frequency of the received signal, each sample having an order k;
a filter for reducing noise outside a required bandwidth, the filter having n taps and comprising:
a first filter portion for receiving the samples where k is even and for outputting an in-phase component I of the received signal, the first filter portion having x taps;
a second filter portion for receiving the samples where k is odd and for outputting a quadrature component Q of the received signal, the second filter portion having y taps;
wherein x+y=n.

2. Apparatus according to claim 1, wherein the DDC is arranged to input samples where k is even into the first filter portion and to input samples where k is odd into the second filter portion.

3. Apparatus according to claim 1 wherein n is odd and
$$x = \frac{n + 1}{2} and y = \frac{n - 1}{2} .$$

4. Apparatus according to claim 1 wherein the first and second filter portions are finite impulse response (FIR) filters.

5. Apparatus according to claim 1 wherein the filter is arranged to perform pulse shaping of the received signal.

6. Apparatus according to claim 5, wherein the first and second filter portions are finite impulse response (FIR) filters and the apparatus further comprises apparatus for pulse shaping the received signal.

7. Apparatus according to claim 5 wherein the first and second filter portions each comprise all or part of a raised cosine filter.

8. Apparatus according to claim 7 wherein the first and second filter portions each comprise a root raised cosine (RRC) filter.

9. Apparatus according to claim 1 further comprising a differential decoder for performing differential detection of I and Q over a given symbol span.

10. Apparatus according to claim 9 wherein the differential decoder is arranged to perform differential detection of I and Q over a symbol span of one symbol.

11. Apparatus according to claim 9 or claim 10 wherein the differential decoder comprises a decision block for converting the differentially decoded I into an I output and for converting the differentially decoded Q into a Q output, the I output and the Q output each taking a value of either 0 or 1.

12. Apparatus according to claim 1 further comprising a converter for converting the received signal to a digital signal.

13. Apparatus according to claim 12 wherein the converter is an analogue to digital converter (ADC).

14. Apparatus according to claim 12 wherein the converter is a hard limiter.

15. Apparatus according to claim 1 further comprising a decimator for reducing sampling frequency of the received signal.

16. Apparatus according to claim 15, wherein the decimator is a cascaded integrator comb (CIC) filter.

17. Apparatus according to any claim 1 wherein the received signal is a differentially encoded phase shift keyed (DPSK) signal.

18. Apparatus according to claim 17 wherein the received signal is
$$\frac{π}{4} DQPSK$$
modulated.

19. A receiver for intermediate frequency signals, the receiver comprising apparatus according to claim 1.

20. A method for isolating an in-phase component I and a quadrature component Q of a received intermediate frequency (IF) signal and for filtering the received signal, the method comprising the steps of:
a) sampling the received signal at four times the frequency of the received signal, each sample having an order k;
b) filtering the signal in a filter having n taps by:
i) inputting samples where k is even into a first filter portion, to generate an in-phase component I of the received signal, the first filter portion having x taps; and
ii) inputting samples where k is odd into a second filter portion to generate a quadrature component Q of the received signal, the second filter portion having y taps,
wherein x+y=n.

21. A method according to claim 20 wherein n is odd and
$$x = \frac{n + 1}{2} and y = \frac{n - 1}{2} .$$

22. A method according to claim 20, further comprising the step of pulse shaping the received signal.

23. A method according to claim 20 wherein the first and second filter portions are finite impulse response (FIR) filters.

24. A method according to claim 20 wherein the first and second filter portions each comprise all or part of a raised cosine filter.

25. A method according to claim 24 wherein the first and second filter portions each comprise a root raised cosine (RRC) filter.

26. A method according to claim 20 further comprising the step of performing differential detection of I and Q over a given symbol span.

27. A method according to claim 26 wherein the differential detection of I and Q is performed over a symbol span of one symbol.

28. A method according to claim 26 further comprising the steps of converting the differentially decoded I into an I output and converting the differentially decoded Q into a Q output, the I output and the Q output each taking a value of either 0 or 1.

29. A method according to claim 20 further comprising the step of converting the received signal to a digital signal.

30. A method according to claim 29 wherein the step of converting the received signal to a digital signal is performed in an analogue to digital converter (ADC).

31. A method according to claim 29 wherein the step of converting the received signal to a digital signal is performed in a hard limiter.

32. A method according to claim 20 further comprising the step of reducing sampling frequency of the received signal.

33. A method according to claim 32 wherein the step of reducing the sampling frequency is performed in a cascaded integrator comb (CIC) filter.

34. A method according to claim 20 wherein the received signal is a differentially encoded phase shift keyed signal.

35. A method according to claim 34 wherein the received signal is
$$\frac{π}{4} DQPSK$$
modulated.

36. Apparatus for carrying out a method according to claim 20.

37. A receiver for intermediate frequency signals, for carrying out a method according to claim 20.

38. A method for isolating an in-phase component I and a quadrature component Q of a received intermediate frequency (IF) signal and for filtering the received signal, the method comprising the steps of:
a) bandpass sampling the received signal by:
i) isolating an aliased signal from the received signal; and
ii) sampling the aliased signal at four times the frequency of the aliased signal, each sample having an order k
b) filtering the signal in a filter having n taps by: i) inputting samples where k is even into a first filter portion, to generate an in-phase component I of the received signal, the first filter portion having x taps; and ii) inputting samples where k is odd into a second filter portion to generate a quadrature component Q of the received signal, the second filter portion having y taps, wherein x+y=n.
